(19) United States
(12) Patent Application Publication
(10) Pub. No.: US 2026/0148421 A1
(43) Pub. Date: May 28, 2026

(54) METHOD FOR GENERATING LOW-RESOLUTION AND HIGH-RESOLUTION DATA PAIR AND MEDICAL IMAGING SYSTEM

(71) Applicant: GE Precision Healthcare LLC, Waukesha, WI (US)

(72) Inventors: Jingting Li, Beijing (CN); Xueli Wang, Beijing (CN); Xiaokun Huang, Beijing (CN)

(21) Appl. No.: 19/401,858

(22) Filed: Nov. 26, 2025

(30) Foreign Application Priority Data
Nov. 28, 2024 (CN) 202411721622.3

(51) Int. Cl. G06T 7/00

(52) U.S. Cl. CPC G06T 7/97; G06T 2207/10081; G06T 2207/20081; G06T 2207/30008

(57) ABSTRACT

The present disclosure relates to a method for generating a low-resolution and high-resolution data pair and a medical imaging system. The method includes: constructing a low-resolution medical imaging system and a high-resolution medical imaging system by using simulation software; performing a first simulated scan on a simulated phantom of a scanned subject by using the low-resolution medical imaging system to obtain low-resolution data; performing a second simulated scan on the simulated phantom of the scanned subject by using the high-resolution medical imaging system to obtain high-resolution data; and associating the low-resolution data of the scanned subject with the high-resolution data of the scanned subject to generate a low-resolution and high-resolution data pair of the scanned subject.

### CROSS-REFERENCE TO RELATED APPLICATIONS

This application claims priority to Chinese Application No. 202411721622.3, filed on Nov. 28, 2024, the disclosure of which is incorporated herein by reference in its entirety.

### TECHNICAL FIELD

The present disclosure relates to the field of medical imaging, and in particular, to a method for generating a low-resolution and high-resolution data pair, a method for training a neural network, a method for medical imaging, a medical imaging system, a computing device, and a computer-readable storage medium.

### BACKGROUND

Medical imaging devices are used for acquiring an anatomical structure of a scanned subject, and include devices that utilize X-rays to perform medical imaging, e.g., computed tomography (CT), digital X-ray machines, C-arm X-ray machines, digital subtraction angiography X-ray machines, mammography X-ray machines, etc. For example, when a CT device performs a scan, an X-ray tube emits X-rays. The X-rays pass through a test object and are attenuated. A detector receives the attenuated X-rays, and converts the same into an electrical signal. After a series of processing, a computer reconstructs medical tomographic images for diagnostic reference.

For CT images, a higher resolution may improve diagnostic performance. Non-hardware-based methods to improve CT image resolution include signal denoising, reconstruction algorithm design, and image enhancement. These methods may have problems such as image distortion.

### SUMMARY OF THE INVENTION

The present disclosure is directed to overcoming the above and/or other problems in the prior art, and provides a method for generating a low-resolution and high-resolution data pair. The generated data pair may be used to implement deep learning-based image resolution improvement.

According to a first aspect of the present disclosure, a method for generating a low-resolution and high-resolution data pair is provided. The method includes the following steps: constructing a low-resolution medical imaging system and a high-resolution medical imaging system by using simulation software; performing a first simulated scan on a simulated phantom of a scanned subject by using the low-resolution medical imaging system to obtain low-resolution data; performing a second simulated scan on the simulated phantom of the scanned subject by using the high-resolution medical imaging system to obtain high-resolution data; and associating the low-resolution data of the scanned subject with the high-resolution data of the scanned subject to generate a low-resolution and high-resolution data pair of the scanned subject.

Optionally, the low-resolution medical imaging system includes a clinical CT imaging system suitable for scanning a human body, and the high-resolution medical imaging system includes a Micro-CT imaging system or a CBCT imaging system.

Optionally, a voxel size of the simulated phantom is smaller than or equal to an equivalent size of a detector cell of the high-resolution medical imaging system at an isocenter of the high-resolution medical imaging system.

Optionally, the method further includes: acquiring a three-dimensional medical image of the scanned subject; and converting the three-dimensional medical image into a three-dimensional voxel matrix to generate the simulated phantom, wherein each voxel in the three-dimensional voxel matrix is assigned a corresponding ray attenuation coefficient.

Optionally, the three-dimensional medical image of the scanned subject is acquired by performing a real scan on the scanned subject by using a hardware-based high-resolution medical imaging system.

Optionally, a positional relationship of a ray source, a scanned subject, and a detector used in the first simulated scan is the same as a positional relationship of a ray source, a scanned subject, and a detector used in the second simulated scan.

Optionally, associating the low-resolution data of the scanned subject with the high-resolution data of the scanned subject includes registering the low-resolution data with the high-resolution data.

Optionally, the low-resolution medical imaging system has at least one of a larger focal spot size, a larger detector cell size, and a smaller number of views per rotation than the high-resolution medical imaging system.

Optionally, the method further includes: performing a plurality of first simulated scans based on a plurality of imaging settings by using the low-resolution medical imaging system to obtain a plurality of pieces of low-resolution data; performing a plurality of second simulated scans based on the plurality of imaging settings by using the high-resolution medical imaging system to obtain a plurality of pieces of high-resolution data; and associating the low-resolution data and the high-resolution data obtained based on each imaging setting to generate a plurality of low-resolution and high-resolution data pairs.

Optionally, the plurality of imaging settings have different imaging parameters, the imaging parameters including at least one of the following: anatomical structure content of the scanned subject, a position of the scanned subject, a direction of the scanned subject, a size of the scanned subject, a radiation dose, a noise level, and a parameter of a filter.

Optionally, the low-resolution data includes low-resolution projection data, and the high-resolution data includes high-resolution projection data.

Optionally, the projection data includes at least one of two-dimensional projection data for a view direction, a sinogram for a row direction, and three-dimensional projection data.

Optionally, the low-resolution data includes a low-resolution reconstructed medical image, and the high-resolution data includes a high-resolution reconstructed medical image.

Optionally, the low-resolution data includes a forward projection of a low-resolution reconstructed medical image, and the high-resolution data includes a forward projection of a high-resolution reconstructed medical image.

Optionally, the scanned subject includes at least one of a temporal bone, a head, and limbs.

According to a second aspect of the present disclosure, a method for training a neural network is provided. The method includes: feeding a training data set to a neural network. The training data set includes one or more pieces of data pairs. Each data pair includes a low-resolution and high-resolution data pair generated by using the method described above. An input of the neural network includes the low-resolution data, and an output of the neural network includes the high-resolution data. The method further includes training the neural network in a supervised manner based on the training data set.

According to a third aspect of the present disclosure, a method for medical imaging is provided. The method includes: receiving medical imaging data of an examination subject, wherein the medical imaging data is obtained by scanning the examination subject by a medical imaging system; inputting the medical imaging data into a neural network to output high-resolution medical imaging data, the high-resolution medical imaging data having a higher resolution than the medical imaging data, wherein the neural network is trained by using the method for training a neural network as described above; and reconstructing the high-resolution medical imaging data to obtain a medical image for diagnosis.

Optionally, the medical imaging data includes sinusoidal projection data.

According to a fourth aspect of the present disclosure, a medical imaging system is provided, including: a medical imaging device, configured to acquire medical imaging data of an examination subject; and a computing device, configured to perform the method for medical imaging described above.

According to a fifth aspect of the present disclosure, a computing device is provided, including: at least one processor; and a memory communicatively connected to the at least one processor, wherein the memory has instructions stored therein, and the instructions, when executed by the at least one processor, implement the method for generating a low-resolution and high-resolution data pair as described above.

According to a sixth aspect of the present disclosure, a computer-readable storage medium having a computer program stored thereon is provided, wherein the program, when executed by a processor, implements the steps of the method for generating a low-resolution and high-resolution data pair described above.

### BRIEF DESCRIPTION OF THE DRAWINGS

The present disclosure can be better understood by means of the description of the exemplary embodiments of the present disclosure in conjunction with the drawings, in which:

FIG. 1 shows an exemplary CT imaging system.

FIG. 2 shows an exemplary imaging system similar to the CT imaging system in FIG. 1.

FIG. 3 is a schematic diagram of a CT system when detecting a patient.

FIG. 4 is a schematic flowchart of a method for generating a low-resolution and high-resolution data pair according to an exemplary embodiment of the present disclosure.

FIG. 5 is an exemplary schematic diagram of a low-resolution medical imaging system setting and a high-resolution medical imaging system setting and imaging thereof.

FIG. 6 is a schematic flowchart of a simulated phantom generation process according to an exemplary embodiment of the present disclosure.

FIG. 7 is an exemplary schematic diagram of a simulated phantom generation process.

FIG. 8 is a schematic flowchart of a data augmentation process according to an exemplary embodiment of the present disclosure.

FIG. 9 shows an example in which a plurality of imaging settings have different imaging parameters.

FIG. 10A and FIG. 10B are schematic diagrams of projection data and images generated in a scanning process of an imaging system.

FIG. 11 is a flowchart of a method for training a neural network according to an exemplary embodiment of the present disclosure.

FIG. 12 is a flowchart of a method for medical imaging according to an exemplary embodiment of the present disclosure.

FIG. 13 shows an example of an electronic device according to an embodiment of the present disclosure.

### DETAILED DESCRIPTION

Specific embodiments of the present disclosure will be described below, but it should be noted that in the specific description of these embodiments, for the sake of brevity of description, it is impossible to describe all features of the actual embodiments of the present disclosure in detail in this description. It should be understood that in the actual implementation process of any implementation, just as in the process of any one engineering project or design project, a variety of specific decisions are often made to achieve specific goals of the developer and to meet system-related or business-related constraints, which may also vary from one implementation to another. Furthermore, it should also be understood that although efforts made in such development processes may be complex and tedious, for those of ordinary skill in the art related to the content of the present disclosure, some design, manufacture, or production changes made on the basis of the technical content disclosed in the present disclosure are only common technical means, and should not be construed as the content of the present disclosure being insufficient.

Unless otherwise defined, the technical or scientific terms used in the claims and the description should be as they are usually understood by those possessing ordinary skill in the technical field to which they belong. The terms “first,” “second,” and the like used in the description and claims of the patent application of the present disclosure do not denote any order, quantity, or importance, but are merely intended to distinguish between different constituents. The terms “one,” “a/an,” and the like do not denote a limitation of quantity, but rather denote the presence of at least one of the referenced items. The terms “include,” “include,” and the like are intended to mean that an element or article that appears before “include” or “include” encompasses elements or articles and equivalent elements that are listed after “include” or “include,” and do not exclude other elements or articles. The terms “connect,” “connected,” and the like are not limited to physical or mechanical connection, and are not limited to direct or indirect connection. “Examination subject” generally includes, but is not limited to, a patient, an animal, or other subjects examined by a medical imaging device.

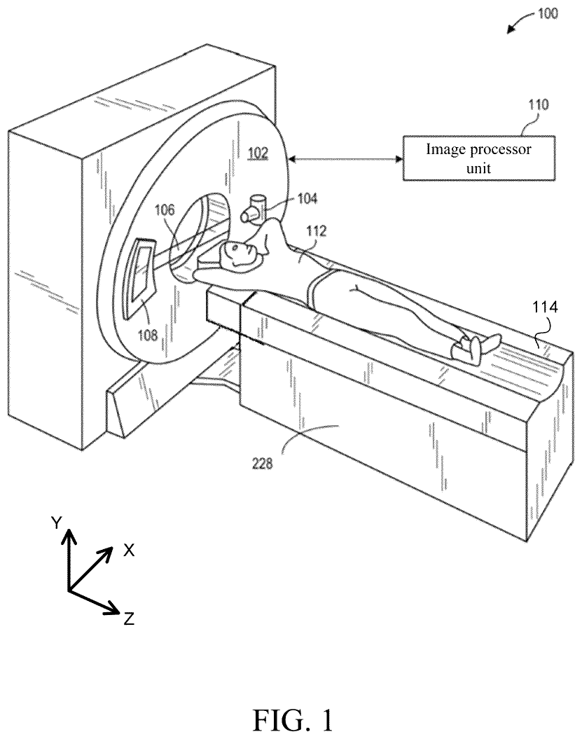

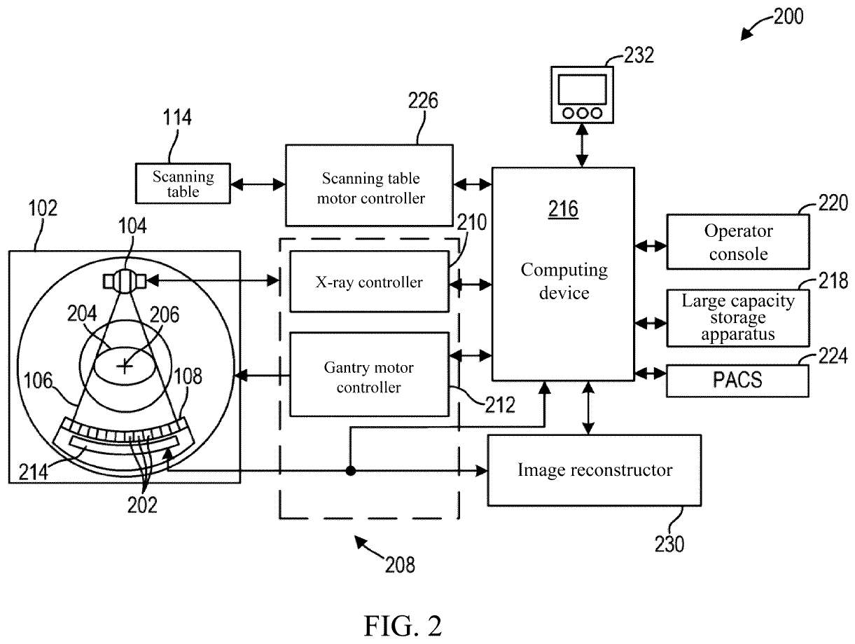

FIG. 1 and FIG. 2 show exemplary embodiments of an imaging system. A method for medical imaging provided by an embodiment of the present disclosure may be applied to the imaging system. While a CT system is described by way of example, it should be understood that the present technique may also be applied to other imaging modalities, such as an X-ray imaging system, a magnetic resonance imaging (MRI) system, a nuclear medical imaging system, a positron emission tomography (PET) imaging system, a single photon emission computed tomography (SPECT) imaging system, an ultrasonic imaging system, and combinations thereof (e.g., a multi-modal imaging system such as a PET/CT or PET/MR imaging system). The discussion on CT imaging modalities in the present disclosure is provided only as an example of one suitable imaging modality.

FIG. 1 shows an exemplary CT imaging system 100 configured for CT imaging. Specifically, the CT imaging system 100 is configured to image an examination subject 112 (such as a patient, an inanimate subject, or one or more manufactured components) and/or a foreign subject (such as a dental implant, a stent, and/or a contrast agent present in the body). In one embodiment, the CT imaging system 100 includes a gantry 102, which in turn may further include at least one X-ray source 104. The at least one X-ray source is configured to project an X-ray radiation beam 106 for imaging the examination subject 112 lying on a scanning table 114. Specifically, the X-ray source 104 is configured to project the X-ray radiation beam 106 toward a detector array 108 positioned on the opposite side of the gantry 102. Although FIG. 1 depicts only a single X-ray source 104, in certain implementations, a plurality of X-ray sources and detectors may be used to project a plurality of X-ray radiation beams 106, so as to acquire projection data corresponding to the patient at different energy levels. In some implementations, the X-ray source 104 may achieve dual-energy gemstone spectral imaging (GSI) by means of rapid peak kilovoltage (kVp) switching. In some implementations, the X-ray detectors which are used are photon counting detectors capable of distinguishing X-ray photons of different energies. In other implementations, dual-energy projections are generated using two sets of X-ray sources and detectors, wherein one set of X-ray sources and detectors is set to low kVp and the other set is set to high kVp. It should therefore be understood that the methods described herein may be implemented using single-energy acquisition techniques and dual-energy acquisition techniques.

In some embodiments, the CT imaging system 100 further includes an image processor unit 110, which is configured to reconstruct an image of a target volume of the examination subject 112 by using an iterative or analytical image reconstruction method. For example, the image processor unit 110 may reconstruct an image of a target volume of the patient using an analytical image reconstruction method such as filtered back projection (FBP). As another example, the image processor unit 110 may reconstruct the image of the target volume of the examination subject 112 in an iterative image reconstruction method (e.g., advanced statistical iterative reconstruction (ASIR), conjugate gradient (CG), maximum likelihood expectation maximization (MLEM), model-based iterative reconstruction (MBIR), etc.). As further described herein, in some examples, in addition to the iterative image reconstruction method, the image processor unit 110 may use an analytical image reconstruction method (such as FBP).

In some CT imaging system configurations, the X-ray source projects a conical X-ray radiation beam, which is collimated to be located within an X-Y-Z plane of a Cartesian coordinate system, and the plane is usually referred to as an “imaging plane”. The X-ray radiation beam passes through a subject being imaged, e.g., a patient or an examination subject. The X-ray radiation beam is irradiated on a detector element array after being attenuated by the subject. The intensity of the attenuated X-ray radiation beam received at the detector array depends on the attenuation of the radiation beam by the subject. Each detector element of the array produces a separate electrical signal that is a measure of the X-ray beam attenuation at the detector position. Attenuation measurements from all detector elements are individually acquired to generate a transmission profile.

In some CT imaging systems, a gantry is used to rotate the X-ray source and the detector array in the imaging plane around the subject to be imaged so that the angle at which the radiation beam intersects the subject is constantly changing. A set of X-ray radiation attenuation measurement results (e.g., projection data) from the detector array at one gantry angle is referred to as a “view”. A “scan” of the subject includes a set of views made at different gantry angles or viewing angles during one rotation of the X-ray source and detector. It can be contemplated that benefits of the method in this specification derive from a medical imaging modality other than CT. Therefore, as used herein, the term “view” is not limited to the use described above with respect to projection data from one gantry angle. The term “view” is used to mean one data acquisition when there are a plurality of data acquisitions (acquisitions from CT, positron emission tomography (PET), or single photon emission CT (SPECT)) from different angles, and/or any other modality (including a modality to be developed) and combinations thereof in fused embodiments.

Projection data is processed to reconstruct images corresponding to two-dimensional slices acquired by means of the subject, or in some examples in which the projection data includes a plurality of views or scans, reconstruct the images corresponding to three-dimensional rendering of the subject. A method for reconstructing an image from a set of projection data is referred to as a filtered back projection technique in the art. Transmission and emission tomography reconstruction techniques also include statistical iterative methods, such as maximum likelihood expectation maximization (MLEM) and ordered subset expectation reconstruction techniques, as well as iterative reconstruction techniques. The method converts an attenuation measurement from a scan into an integer referred to as a “CT number” or “Hounsfield unit”, which is used to control the brightness of a corresponding pixel on a display device.

To reduce the total scan time, a “helical” scan may be performed. To perform the “helical” scan, the patient is moved when data of a specified number of slices is acquired. Such systems produce a single helix from helical scanning of a conical beam. The helix mapped out by the conical beam produces projection data according to which an image in each specified slice can be reconstructed.

As used herein, the phrase “reconstructed image” is not intended to exclude embodiments of the present disclosure in which data representing an image is generated rather than a viewable image. Thus, as used herein, the term “image” broadly refers to both a viewable image and data representing a viewable image. However, many embodiments generate (or are configured to generate) at least one viewable image.

FIG. 2 shows an exemplary imaging system 200 similar to the CT imaging system 100 in FIG. 1. According to aspects of the present disclosure, the imaging system 200 is configured to image the examination subject 204 (e.g., the examination subject 112 in FIG. 1). In one embodiment, the imaging system 200 includes the detector array 108 (see FIG. 1). The detector array 108 further includes a plurality of detector elements 202, which together sense the X-ray radiation beam 106 (see FIG. 2) passing through the examination subject 204 (such as a patient) to acquire corresponding projection data. Therefore, in one embodiment, the detector array 108 is fabricated in a multi-slice configuration including a plurality of rows of units or detector elements 202. In such configurations, one or more additional rows of detector elements 202 are arranged in a parallel configuration for acquiring projection data.

In certain implementations, the imaging system 200 is configured to traverse different angular positions around the examination subject 204 to acquire required projection data. Therefore, the gantry 102 and components mounted thereon can be configured to rotate about a center of rotation 206 to acquire projection data at different energy levels, for example. Alternatively, in implementations in which a projection angle with respect to the examination subject 204 changes over time, the mounted components may be configured to move along a generally curved line rather than a segment of a circumference.

Therefore, when the X-ray source 104 and the detector array 108 rotate, the detector array 108 collects the data of the attenuated X-ray beam. The data collected by the detector array 108 is then subjected to pre-processing and calibration to adjust the data so as to represent a line integral of an attenuation coefficient of the scanned examination subject 204. The processed data is generally referred to as projection data.

In some examples, an individual detector or detector element 202 in the detector array 108 may include a photon counting detector that registers interactions of individual photons into one or more energy bins. It should be understood that the methods described herein may also be implemented using an energy integration detector.

An acquired projection data set may be used for base material decomposition (BMD). During the BMD, the measured projection is converted to a set of material density projections. The material density projections may be reconstructed to form one pair or a set of material density maps or images (such as bone, soft tissue, and/or contrast agent maps) of each corresponding base material. The density maps or images may then be associated to form volume rendering of a base material (e.g., bone, soft tissue, and/or a contrast agent) in an imaging volume.

Once reconstructed, a base material image produced by the imaging system 200 displays internal features of the examination subject 204 represented by the densities of two base materials. The density images can be displayed to demonstrate the foregoing features. In a conventional method for diagnosing medical conditions (such as disease states), and more generally for diagnosing medical events, a radiologist or physician considers a hard copy or display of a density image to discern characteristic features of interest. Such features may include a lesion, size, and shape of a particular anatomical structure or organ, and other features should be discernible in the image on the basis of the skill and knowledge of an individual practitioner.

In one implementation, the imaging system 200 includes a control mechanism 208 to control movement of the components, such as the rotation of the gantry 102 and the operation of the X-ray source 104. In certain embodiments, the control mechanism 208 further includes an X-ray controller 210, configured to provide power and timing signals to the X-ray source 104. Additionally, the control mechanism 208 includes a gantry motor controller 212, configured to control the rotational speed and/or position of the gantry 102 on the basis of imaging requirements.

In certain implementations, the control mechanism 208 further includes a data acquisition system (DAS) 214, and the DAS is configured to sample analog data received from the detector elements 202, and convert the analog data to a digital signal for subsequent processing. The DAS 214 may further be configured to selectively aggregate analog data from a subset of the detector elements 202 into a so-called macro detector, as described further herein. The data sampled and digitized by the DAS 214 is transmitted to a computer or computing device 216. In an example, the computing device 216 stores data in a storage device or large-capacity storage apparatus 218. For example, the storage device 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the gantry motor controller 212 to control system operations, such as data acquisition and/or processing. In certain embodiments, the computing device 216 controls system operations on the basis of operator input. The computing device 216 receives the operator input by means of an operator console 220 that is operably connected to the computing device 216, the operator input including, for example, commands and/or scan parameters. The operator console 220 may include a keyboard (not shown) or a touch screen to allow the operator to specify commands and/or scan parameters.

Although FIG. 2 shows only one operator console 220, more than one operator console may be coupled to the imaging system 200, for example, for inputting or outputting system parameters, requesting examination, mapping data, and/or viewing images. Moreover, in certain implementations, the imaging system 200 may be coupled to, for example, a plurality of displays, printers, workstations, and/or similar devices located locally or remotely within an institution or hospital or in a completely different location via one or more configurable wired and/or wireless networks (such as the Internet and/or a virtual private network, a wireless telephone network, a wireless local area network, a wired local area network, a wireless wide area network, a wired wide area network, etc.).

In one implementation, for example, the imaging system 200 includes or is coupled to a picture archiving and communication system (PACS) 224. In an exemplary implementation, the PACS 224 is further coupled to a remote system (such as a radiology information system or a hospital information system) and/or coupled to an internal or external network (not shown) to allow an operator at a different position to provide commands and parameters and/or obtain access to image data.

The computing device 216 uses operator-provided and/or system-defined commands and parameters to operate the scanning table motor controller 226, the scanning table motor controller is able to control the scanning table 114, and the scanning table may be an electrical scanning table. Specifically, the scanning table motor controller 226 moves the scanning table 114 to properly position the examination subject 204 in the gantry 102 to acquire projection data corresponding to a target volume of the examination subject 204.

As described previously, the DAS 214 samples and digitizes the projection data acquired by the detector elements 202. Subsequently, an image reconstructor 230 uses the sampled and digitized X-ray data to perform high-speed reconstruction. Although the image reconstructor 230 is shown as a separate entity in FIG. 2, in certain implementations, the image reconstructor 230 may form a part of the computing device 216. Alternatively, the image reconstructor 230 may not be present in the imaging system 200, and the computing device 216 may instead perform one or more functions of the image reconstructor 230. In addition, the image reconstructor 230 may be located locally or remotely and may be operably connected to the imaging system 200 by using a wired or wireless network. Specifically, in one exemplary embodiment, computing resources in a “cloud” network cluster may be used for the image reconstructor 230.

In one embodiment, the image reconstructor 230 stores a reconstructed image in the storage device 218. Alternatively, the image reconstructor 230 may transmit the reconstructed image to the computing device 216 to generate usable patient information for diagnosis and evaluation. In certain implementations, the computing device 216 may transmit the reconstructed image and/or patient information to a display or display device 232, the display or display device being communicatively coupled to the computing device 216 and/or the image reconstructor 230. In some implementations, the reconstructed image may be transmitted from the computing device 216 or the image reconstructor 230 to the storage device 218 for short-term or long-term storage.

In CT imaging, an X-ray intensity attenuation formula can be used to quantitatively describe attenuation of the intensity of X-rays when passing through different tissues. The X-ray intensity attenuation formula can be expressed as: I=I₀e^{-μx}. I is the X-ray intensity after the X-ray passes through an absorbing medium. I₀ is an initial X-ray intensity, i.e., the intensity before the X-ray passes through no material. μ is a ray attenuation coefficient of the medium for the X-ray (the unit is usually cm⁻¹), and is related to a tissue type, different tissues having different attenuation coefficients. x is the path length of the X-ray passing through the medium (e.g., the thickness of the absorbing medium). In CT imaging, an X-ray beam emitted by the X-ray source passes through a patient's body, and different tissues absorb the X-ray differently, resulting in different intensities received by a detector. The X-ray intensity at different locations is measured, so that an image of an internal structure can be reconstructed.

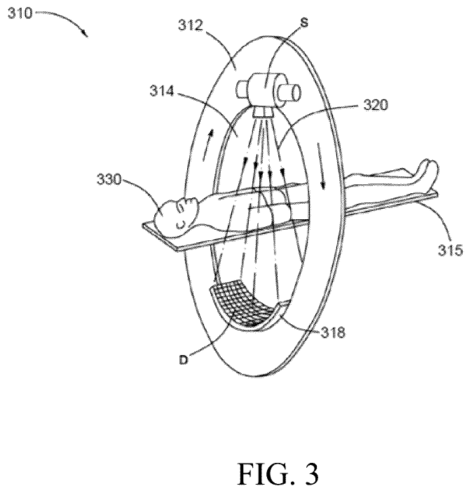

FIG. 3 is a schematic diagram of a CT system when detecting a patient. As shown in FIG. 3, the CT system 310 generally includes a rotatable gantry 312 and a support table 315 disposed in a hollow imaging region 314 of the rotatable gantry 312 for carrying a patient 330. The rotatable gantry 312 includes an X-ray source S and a detector 318 arranged opposite to the X-ray source S. The detector 318 includes a plurality of individual detector cells D arranged in an array. When the rotatable gantry 312 is located at a certain scanning position, the X-ray source S emits a fan-shaped X-ray beam 320 toward the detector 318, and the plurality of detector cells D respectively sense the X-rays attenuated by the patient 330, so that a set of projection data is obtained through sensing by the detector cells D to obtain a corresponding frame of projection data. With the rotation of the rotatable gantry 312, the X-ray source S and the detector 318 rotate around a center of the rotation O. The CT system 310 performs a plurality of scans. In each scan process, all the detector cells D may sense and obtain each corresponding frame of projection data. In the case where the detector cells D are normal, each corresponding frame of projection data may be directly used to reconstruct one or more images. A scanning translation direction of the CT system 310 along the row of the detector 318 is referred to as a row direction, the width direction of the CT system 310 along the detector 318 is referred to as a channel direction, and a scanning rotation angle of the CT system 310 is referred to as a view direction.

To obtain a clearer reconstructed medical image, the resolution of the medical image may be improved through artificial intelligence. Some methods use generative or unsupervised machine learning methods to optimize image quality, but such methods are not suitable for optimization of medical images because medical images are more focused on fidelity and accuracy, while generative or unsupervised machine learning methods tend to increase some unrealistic detail information. In this regard, the inventors of the present disclosure have conceived that a neural network based on a supervised learning may be used to optimize the medical image, thereby ensuring the fidelity and accuracy of the medical image. Therefore, it is necessary to provide image data pairs for the neural network based on the supervised learning to train.

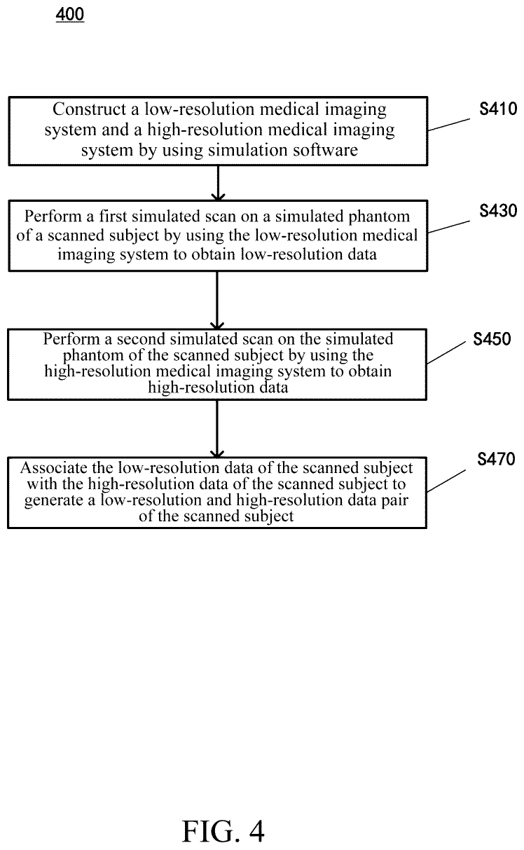

Referring to FIG. 4, FIG. 4 is a schematic flowchart of a method 400 for generating a low-resolution and high-resolution data pair according to an exemplary embodiment of the present disclosure. As shown in FIG. 4, the method 400 for generating a low-resolution and high-resolution data pair according to the embodiment may include the following steps S410 to S470.

In step S410, a low-resolution medical imaging system and a high-resolution medical imaging system are constructed by using simulation software.

A first medical imaging system may be constructed by using the simulation software, and the first medical imaging system can generate a medical image having a first resolution. A second medical imaging system may be constructed by using the same or different simulation software, and the second medical imaging system can generate a medical image having a second resolution. The first resolution may be different from the second resolution. The simulation software simulates components, working processes, and imaging results of medical imaging devices (such as CT, MRI, and DR) via a computer. For example, for CT imaging, the simulation software may simulate all components in a CT imaging system, including X-ray generation, beam shaping and filtering, a scanned subject, an interaction between X-rays and the scanned subject, a detection process, and image reconstruction.

In some embodiments, the low-resolution medical imaging system and the high-resolution medical imaging system have the same geometry size or parameters, such as the relative position of a ray source, an examination subject under, and a detector, except that the low-resolution medical imaging system may have at least one of a larger focal spot size (tube focal spot), a larger detector cell size, and a smaller number of views per rotation than the high-resolution medical imaging system.

In step S430, a first simulated scan is performed on a simulated phantom of a scanned subject by using the low-resolution medical imaging system to obtain low-resolution data.

The scanned subject may be characterized by a voxelized phantom having a small-sized structure of interest as the simulated phantom of the scanned subject. In some embodiments, the simulated phantom may be used to simulate a real human body or a human body part. The voxelized phantom is a discrete 3-D representation of a subject. For example, for CT imaging, each voxel may be assigned a material-specific ray attenuation coefficient (i.e., μ value), so that the CT imaging system can calculate the interaction of each voxel with X-rays. As an example, the scanned subject may include at least one of a temporal bone, a head, and limbs.

The first simulated scan may be performed on the simulated phantom serving as the scanned subject by using a low-resolution imaging system. The first simulated scan generates low-resolution data that simulates imaging data that an actual low-resolution imaging system may generate.

In step S450, a second simulated scan is performed on the simulated phantom of the scanned subject by using the high-resolution medical imaging system to obtain high-resolution data.

The second simulated scan may be performed on the same scanned subject or simulated phantom as in Step S430 by using the high-resolution imaging system. The second simulated scan generates high-resolution data that simulates imaging data that an actual high-resolution imaging system may generate.

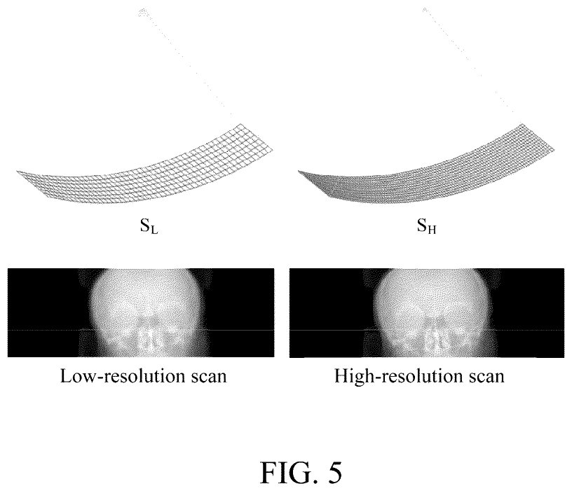

Referring to FIG. 5, depicted is an exemplary schematic diagram of a low-resolution medical imaging system setting and a high-resolution medical imaging system setting and imaging thereof. In this example, the low-resolution medical imaging system and the high-resolution medical imaging system have the same overall detector size but different detector cell or pixel sizes, and the detector cell size of the low-resolution medical imaging system setting S_{L} is relatively large for generating low-resolution scan data. The detector cell size of the high-resolution medical imaging system setting S_{H} is relatively small for generating high-resolution scan data. For example, the detector cell size of the low-resolution medical imaging system setting S_{L} has a first size, and the detector cell size of the high-resolution medical imaging system setting S_{H} has a second size. The first size is larger than the second size. The first size and the second size may include the side length, the circumference, or the area of the detector cell or pixel. Accordingly, the density of detector cell of the low-resolution medical imaging system setting S_{L} is smaller than the density of detector cell of the high-resolution medical imaging system setting S_{H} when the two settings have the same overall detector size.

In step S470, the low-resolution data of the scanned subject is associated with the high-resolution data of the scanned subject to generate a low-resolution and high-resolution data pair of the scanned subject.

The low-resolution data and the high-resolution data obtained in step S430 and step S450, respectively are associated with each other. This association is based on the same scanned subject, meaning that each pair of data is obtained from the same phantom or image region, but represents imaging results of different resolutions, separately. In other words, the associated low-resolution data and high-resolution data may have an image registration relationship therebetween without transformation.

The method for generating a low-resolution and high-resolution data pair according to an exemplary embodiment of the present disclosure is described above. By using the method, the large number of low-resolution and high-resolution data pairs can be generated without actually performing a plurality of physical scans. By comparing and analyzing these data pairs, it is possible to better understand the performance differences of different imaging systems, optimize imaging algorithms, improve image quality, and develop new image processing techniques. For example, these data pairs may be used to train a neural network for implementing neural network-based image resolution improvement.

In some embodiments, the low-resolution medical imaging system may include a clinical CT imaging system for scanning a human body, and the high-resolution medical imaging system may include a Micro-CT imaging system or a CBCT imaging system. The clinical CT imaging system is a CT scanning device widely used in medical facilities (e.g., hospitals or clinics) for performing various diagnostic imaging on the human body. The clinical CT imaging system is designed to provide sufficient resolution to meet most clinical needs, but may have lower resolution compared to a specialized research device. Micro-CT (micro-computed tomography) is a high-resolution CT technology that can provide detailed images at the microscopic level. This technology is commonly used in materials science, biology, and medical research, especially where observation of fine structures is required. The Micro-CT imaging system can provide higher resolution than the clinical CT imaging system, and is suitable for observing small-sized structures, such as bone tissue, teeth, or tiny blood vessels. Cone beam computed tomography (CBCT) is a CT technology using a cone-shaped X-ray beam, commonly applied to dental and maxillofacial imaging. The CBCT imaging system can provide higher resolution and less radiation dose than the clinical CT imaging system, and is particularly suitable for dental application, such as implant planning and orthodontic treatment evaluation. By simulating these different types of CT imaging systems, imaging effects of different resolutions may be simulated, thereby generating the low-resolution and high-resolution data pair.

In some embodiments, a voxel size of the simulated phantom is smaller than or equal to an equivalent size of the detector cell of the high-resolution medical imaging system at an isocenter (i.e., isocenter or iso center). For the simulated phantom, the voxel size is smaller than or equal to the equivalent size of the detector cell of the high-resolution medical imaging system at the isocenter, which means that the simulated phantom can provide sufficiently detailed data to match the capability of the high-resolution imaging system. In the CT imaging system, the isocenter is the center of a scanning gantry, that is, the center point of the rotation of the X-ray source and detector. The equivalent size of the detector cell at the isocenter is the smallest size that the detector cell can resolve at the point.

In some embodiments, a positional relationship of a ray source, a scanned subject, and a detector used in the first simulated scan is substantially the same as a positional relationship of a ray source, a scanned subject, and a detector used in the second simulated scan. When the first simulated scan (low-resolution scan) and the second simulated scan (high-resolution scan) are performed, the positional relationship among the ray source, the scanned subject, and the detector is kept substantially the same, which can ensure that the geometric conditions or scan fields of view of the two scans are consistent. When generating the low-resolution and high-resolution data pair, keeping the positional relationship substantially the same may enable these data pairs to have matchability (for example, registration between the low-resolution data and the high-resolution data), and eliminate the difference between the low-resolution data and the high-resolution data caused by different positions of the ray source, the scanned subject, and the detector.

In some embodiments, associating the low-resolution data of the scanned subject with the high-resolution data of the scanned subject includes registering the low-resolution data with the high-resolution data.

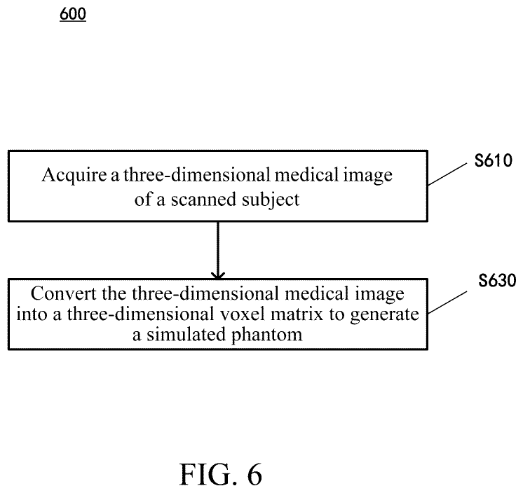

Referring to FIG. 6, depicted is a schematic flowchart of a simulated phantom generation process 600 according to an exemplary embodiment of the present disclosure. As shown in FIG. 6, the method 400 for generating a low-resolution and high-resolution data pair according to an optional embodiment further may further include the simulated phantom generation process 600. The simulated phantom generation process 600 may include steps S610 and S630.

In step S610, a three-dimensional medical image of a scanned subject is acquired.

A three-dimensional medical image of the scanned subject may be acquired by performing a real scan on the scanned subject by using a hardware-based high-resolution medical imaging system. In some embodiments, the three-dimensional medical image of the scanned subject may be acquired by performing a real scan on the scanned subject by using a hardware-based high-resolution medical imaging system. For example, a physical high-resolution medical imaging system such as a Micro-CT imaging system or a CBCT imaging system may be used to perform real scan on the scanned subject to obtain the three-dimensional medical image of the scanned subject.

In step S630, the three-dimensional medical image is converted into a three-dimensional voxel matrix to generate a simulated phantom. Each voxel in the three-dimensional voxel matrix may be assigned a corresponding ray attenuation coefficient (i.e., μ value). In this way, the simulated phantom may be used to calculate the interaction of each voxel with X-rays in simulated scan performed by using a medical imaging system (including the low-resolution medical imaging system and the high-resolution medical imaging system described above) constructed by using simulation software, thereby simulating X-ray imaging of the scanned subject.

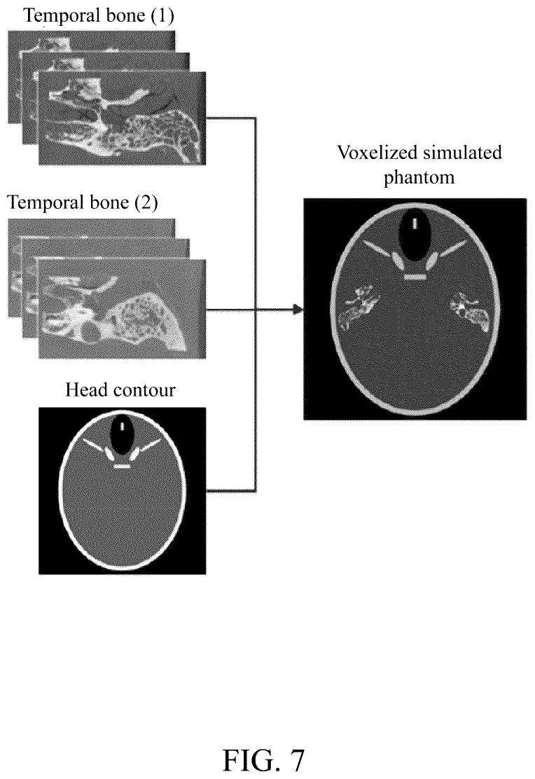

Referring to FIG. 7, depicted is an exemplary schematic diagram of a simulated phantom generation process. In this example, a high-resolution Micro-CT or CBCT three-dimensional medical image of a typical human body anatomical structure with a small size of the anatomical structure, e.g., the temporal bone, is used as a basis. The three-dimensional medical image is then converted into a three-dimensional voxel matrix, and each voxel is assigned a μ value converted from the HU number of the voxel. A common low-resolution medical imaging system setting S_{L} has a detector cell size of 0.625 mm, and for a high-resolution medical imaging system setting S_{H} with a quarter detector cell size (i.e., 0.156 mm at the isocenter), a Micro-CT or CBCT imaging system with a pixel size ranging from 10 μm to 100 μm needs to be sufficient to generate medical images of relevant size. Clinical CT medical images are usually limited by their physical resolution and are not suitable as a source of voxelized phantoms.

The exemplary voxelized phantom of FIG. 7 includes two different temporal bone samples and a head contour. For example, each temporal bone sample may be converted from a CBCT image into a voxelized temporal bone phantom, and then the voxelized temporal bone phantom and the voxelized head phantom are combined to form a simulated phantom of the scanned subject (including the temporal bone structure and the head contour). It can be understood that the simulated phantom shown in FIG. 7 is only used as an example for description, and the scanned subject of the present disclosure is not limited thereto, but may include any part/organ in the human body.

In some embodiments, the method for generating the low-resolution and high-resolution data pair may further include a data augmentation process. The data augmentation process may include conducting a plurality of simulated scans based on a plurality of imaging settings including the first medical imaging system and the second medical imaging system, thereby increasing the number of low-resolution and high-resolution data pairs.

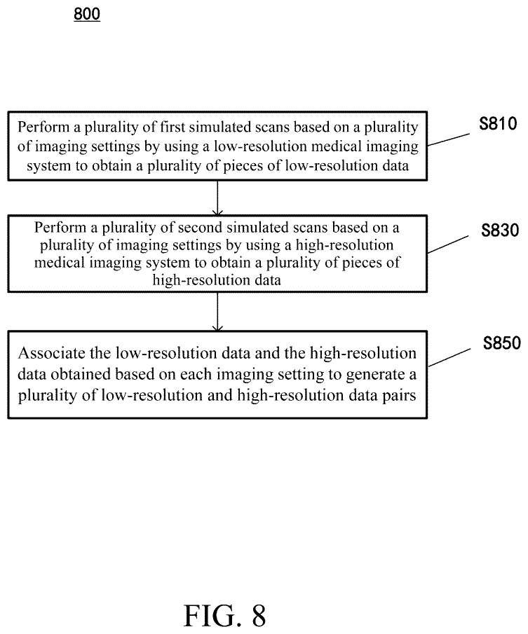

Referring to FIG. 8, depicted is a schematic flowchart of a data augmentation process 600 according to an exemplary embodiment of the present disclosure. As shown in FIG. 8, the method 400 for generating a low-resolution and high-resolution data pair according to an optional embodiment may further include the data augmentation process 800. The data augmentation process 800 may include steps S810 and S850.

In step S810, a plurality of first simulated scans are performed based on a plurality of imaging settings by using the low-resolution medical imaging system to obtain a plurality of pieces of low-resolution data.

In step S830, a plurality of second simulated scans are performed by using the high-resolution medical imaging system based on the plurality of imaging settings to obtain a plurality of pieces of high-resolution data.

In step S850, the low-resolution data and the high-resolution data obtained based on each imaging setting are associated to generate a plurality of low-resolution and high-resolution data pair.

Each imaging setting may correspond to a corresponding imaging parameter. The imaging parameters may include: anatomical structure content of the scanned subject, a position of the scanned subject, a direction of the scanned subject, a size of the scanned subject, a radiation dose, a noise level, a parameter of a filter, and the like.

In some embodiments, for the same imaging system, the plurality of imaging settings may have different imaging parameters from each other. It should be noted that the first imaging setting and the second imaging setting have different imaging parameters, which means that at least one imaging parameter of the first imaging setting and the second imaging setting is different from each other, rather than all the imaging parameters are different. For example, the first imaging setting and the second imaging setting of the same imaging system may have the same radiation dose, while the position of the scanned subject may be different.

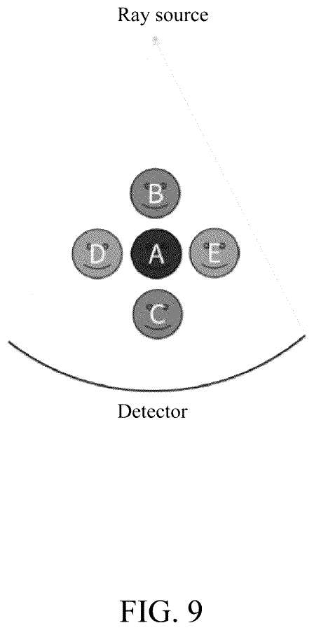

Referring to FIG. 9, an example in which a plurality of imaging settings have different imaging parameters is shown. FIG. 9 shows five different positions of a scanned subject in different imaging settings. For a first imaging setting, the scanned subject may be located at the position A. For a second imaging setting, the scanned subject may be located at the position B. For a third imaging setting, the scanned subject may be located at the position C. For a fourth imaging setting, the scanned subject may be located at the position D. For a fifth imaging setting, the scanned subject may be located at the position E. As an example, a first simulated scan and a second simulated scan may be performed separately based on the first imaging setting by using a low-resolution medical imaging system and a high-resolution medical imaging system to generate a first low-resolution and high-resolution data pair. The first simulated scan and the second simulated scan may be performed separately based on the second imaging setting by using the low-resolution medical imaging system and the high-resolution medical imaging system to generate a second low-resolution and high-resolution data pair. The first simulated scan and the second simulated scan may be performed separately based on the third imaging setting by using the low-resolution medical imaging system and the high-resolution medical imaging system to generate a third low-resolution and high-resolution data pair. The first simulated scan and the second simulated scan may be performed separately based on the fourth imaging setting by using the low-resolution medical imaging system and the high-resolution medical imaging system to generate a fourth low-resolution and high-resolution data pair. The first simulated scan and the second simulated scan may be performed separately based on the fifth imaging setting by using the low-resolution medical imaging system and the high-resolution medical imaging system to generate a fifth low-resolution and high-resolution data pair. This achieves data augmentation of the low-resolution and high-resolution data pair.

A CT scanning device is used as an example. For the same view, projection data blocks at B, C, D, and E are different from a projection data block at A, and this difference cannot be achieved by a simple transformation commonly used for data augmentation (e.g., adjusting the size and flipping of the scanned subject). Therefore, the difference in the position of the scanned subject is considered to be a key imaging parameter that leads to a significant difference in a data set, as are the other imaging parameters described above.

Similarly, a plurality of different imaging settings may be configured by adjusting one or more imaging parameters of the anatomical structure content of the scanned subject, the position of the scanned subject, the direction of the scanned subject, the size of the scanned subject, the radiation dose, the noise level, and the parameter of the filter, and a plurality of low-resolution and high-resolution data pairs are generated based on these plurality of different imaging settings, respectively. It should be noted that the difference in the anatomical structure content of the scanned subject in different imaging settings means the change of the scanned subject itself, including the difference in the anatomical structure of the scanned subject itself or the difference in the combination manner. For example, if the scanned subject of the first imaging setting is the temporal bone, and the scanned subject of the second imaging setting is the head, it means that the first imaging setting and the second imaging setting have different anatomical structure contents of the scanned subject. For another example, if the scanned subject of the first imaging setting is a temporal bone, and the scanned subject of the second imaging setting is the temporal bone and the head, it means that the first imaging setting and the second imaging setting have different anatomical structure contents of the scanned subject.

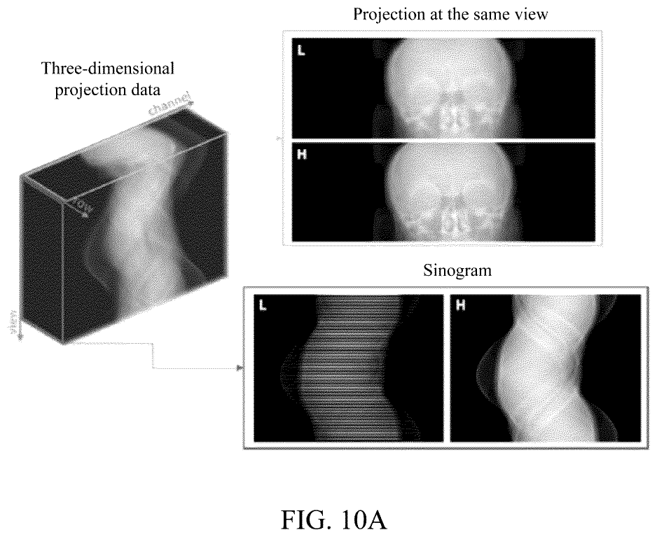

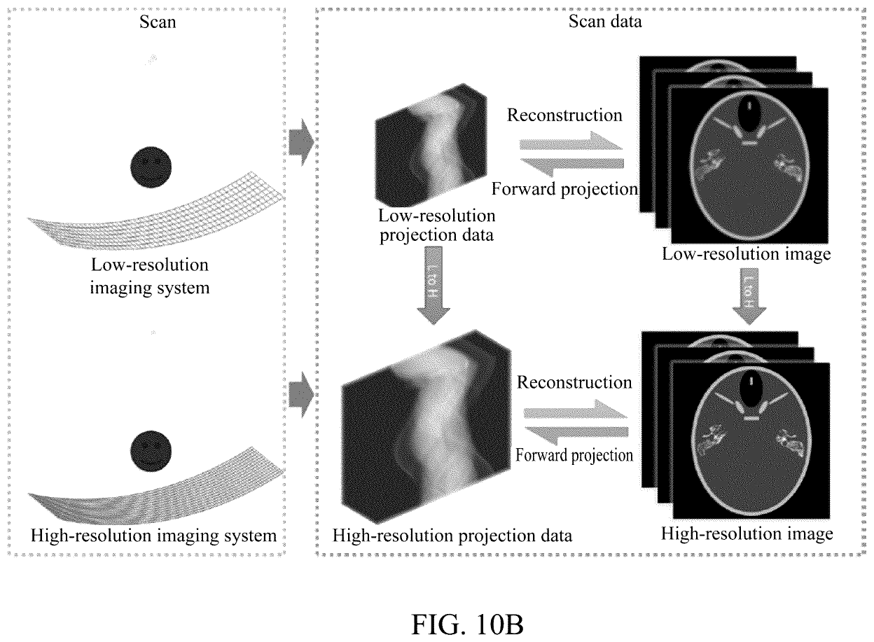

Referring to FIG. 10A and FIG. 10B, schematic diagrams of projection data and images generated in a scanning process of an imaging system are shown. Referring to FIG. 10A, raw projection data obtained by scanning the scanned subject by the low-resolution imaging system and the high-resolution imaging system is a three-dimensional projection data matrix including a channel direction, a row direction, and a view direction. The row direction indicates a direction of a detector of the imaging system in which the scanned subject moves toward or away from the imaging system, the channel direction indicates an extension direction of the detector arranged perpendicular to the row direction and partially around the scanned subject, and the view direction indicates an angle at which the detector acquires projection data at different positions surrounding the scanned subject. For each view, the imaging system scans the scanned subject to obtain two-dimensional X-ray projections. A low-resolution image may be an X-ray projection image of the number of pixels obtained by multiplying the number of channels by the number of pixels. A high-resolution image acquired by using a 1/N detector cell (or pixel) size is an image of N times the number of pixels of the exact same subject (i.e., an examination subject). For example, a detector cell size of the low-resolution system at the isocenter is 0.625 mm with 800 channels and 64 rows, and a detector cell size of the high-resolution system at the isocenter is 0.156 mm with 3200 channels and 256 rows. The low-resolution image is 800×64 pixels, and a corresponding high-resolution image is 3200×256 pixels. For each row, the imaging system scans the scanned subject to obtain a sinogram or a sinusoidal projection map. A low-resolution sinogram and a high-resolution sinogram are defined by the number of views per rotation. For example, the low-resolution sinogram has 1000 views per rotation, while the high-resolution sinogram has 3000 views per rotation.

Referring to FIG. 10B, an image reconstruction process may be used to reconstruct a reconstructed medical image of the scanned subject from projection data, and the reconstructed medical image may visually show a structure of the scanned subject. Forward projection refers to simulating the interaction between X-rays and the scanned subject from a reconstructed image to generate simulated projection data.

In some implementations of the present disclosure, low-resolution data may include projection data of a low resolution, and high-resolution data may include projection data of a high resolution. The projection data may include at least one of two-dimensional projection data or an X-ray projection map for a view direction, a sinogram or a sinusoidal projection map for a row direction, and three-dimensional projection data.

In some implementations of the present disclosure, the low-resolution data may include a low-resolution reconstructed medical image, and the high-resolution data may include a high-resolution reconstructed medical image.

In some implementations of the present disclosure, the low-resolution data may include a forward projection of the low-resolution reconstructed medical image, and the high-resolution data may include a forward projection of a high-resolution reconstructed medical image.

According to an exemplary embodiment of the present disclosure, a method for training a neural network is further provided.

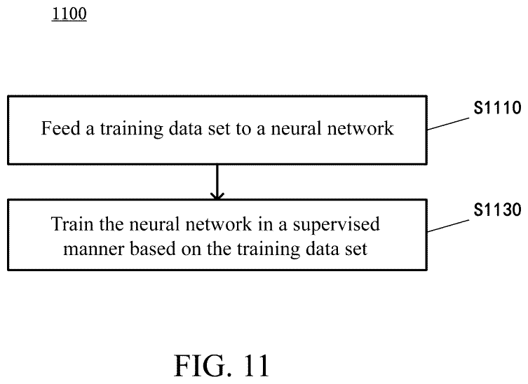

Referring to FIG. 11, a flowchart of a method 1100 for training a neural network according to an exemplary embodiment of the present disclosure is shown. The method 1100 of training a neural network may include steps S1110 and S1130.

In step S1110, a training data set is fed to a neural network.

The training data set includes one or more pieces of data pairs. Each data pair includes a low-resolution and high-resolution data pair generated by using the method 400 for generating a low-resolution and high-resolution data pair as described above. An input of the neural network includes low-resolution data. An output of the neural network includes high-resolution data.

In step S1130, the neural network is trained in a supervised manner based on the training data set.

In some embodiments, the neural network may include any neural network based on supervised learning, for example, a convolutional neural network.

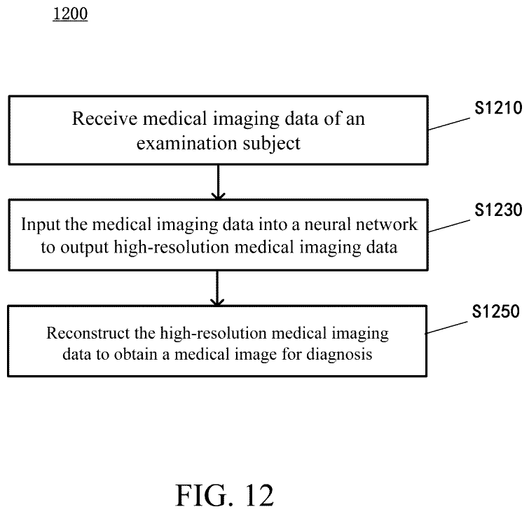

Referring to FIG. 12, a schematic flowchart of a method 1200 for medical imaging according to an exemplary embodiment of the present disclosure is shown. The method 1200 for medical imaging may include steps S1210 to S1250.

In step S1210, medical imaging data of an examination subject is received.

The medical imaging data may be obtained by scanning the examination subject by a medical imaging system. The examination subject is a subject for which a medical image for diagnosis needs to be obtained by using the medical imaging system. In some embodiments, the examination subject includes at least one of a temporal bone, a head, and limbs. The examination subject and the above-described scanned subject may have the same anatomical structure content or may also have different anatomical structure contents.

In step S1230, the medical imaging data is input into a neural network to output high-resolution medical imaging data. The neural network may be trained by using the method 1100 for training a neural network as described above, whereby the medical imaging data output by the neural network may have a higher resolution than the input medical imaging data. It should be noted that the resolution described herein may refer to either or both of the spatial resolution and the temporal resolution.

In step S1250, the high-resolution medical imaging data is reconstructed to obtain a medical image for diagnosis.

In some embodiments, the medical imaging system may use its highest resolution setting to scan the examination subject to obtain medical imaging data, and then the method 1200 for medical imaging may be used to improve the resolution of the medical imaging data, thereby implementing super-resolution imaging of the medical imaging system. In some other embodiments, the medical imaging system may use a low-resolution mode to scan the examination subject to obtain the medical imaging data, and then the method 1200 for medical imaging may be used to improve the resolution of the medical imaging data, thereby implementing high-resolution imaging of the medical imaging system. In this way, the medical imaging system can generate high-resolution data without using a high-resolution mode, which helps to save scanning time while improving diagnostic performance, and improve imaging efficiency and even subsequent diagnosis and treatment efficiency.

According to an exemplary embodiment of the present disclosure, a medical imaging system is further provided. The medical imaging system (for example, the imaging system 100 or 200 in FIG. 1 or FIG. 2, or the CT system 310 in FIG. 3) may include a medical imaging device configured to acquire medical imaging data of the examination subject, and a computing device. The computing device may be configured to perform the method 1200 for medical imaging described above.

According to an exemplary embodiment of the present disclosure, a computer-readable storage medium is further provided. The computer-readable storage medium has a computer program stored thereon. The program, when executed by a processor, implements the steps of the method 400 for generating a low-resolution and high-resolution data pair described above.

According to an exemplary embodiment of the present disclosure, a computer program product is further provided. The computer program product includes instructions. The instructions can be performed by a processor, to implement the method 400 for generating a low-resolution and high-resolution data pair described above.

One or a plurality of the above-described techniques and/or embodiments may be implemented using hardware and/or software or include hardware and/or software, for example, modules or apparatuses executed on one or a plurality of computing devices 216. Of course, the modules or apparatuses described herein show various functions and are not limited to limiting the structure and functions of any embodiment. On the contrary, the functions of various modules or apparatuses may be divided and executed differently according to more or fewer modules or apparatuses considered by various designs.

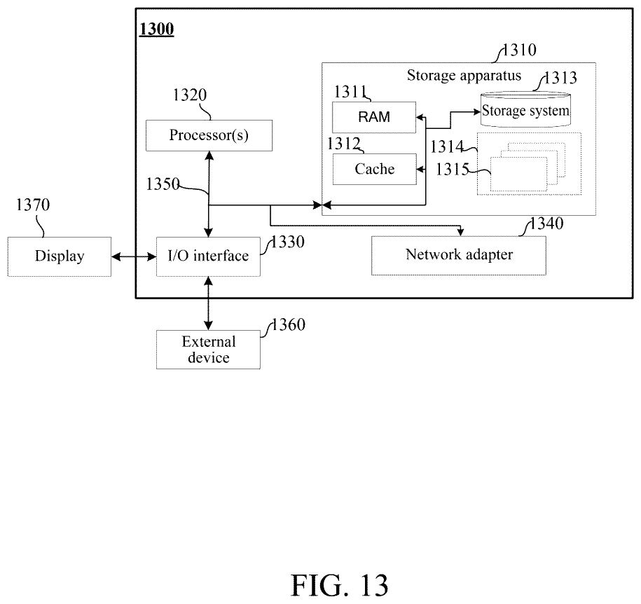

FIG. 13 shows an example of an electronic device 1300 according to an embodiment of the present disclosure. The electronic device 1300 includes: one or more processors 1320; and a storage apparatus 1310, configured to store one or more programs, when the one or more programs are executed by the one or more processors 1320, the one or more processors 1320 implement the method for medical imaging provided in the embodiments of the present disclosure. The processor is, for example, a digital signal processor (DSP), a microcontroller, an application-specific integrated circuit (ASIC), or a microprocessor.

The electronic device 1300 shown in FIG. 13 is merely an example, and should not cause any limitation to the function and use scope of the embodiments of the present disclosure.

As shown in FIG. 13, the electronic device 1300 is represented in the form of a general-purpose computing device. Components of the electronic device 1300 may include, but are not limited to: one or more processors 1320, a storage apparatus 1310, and a bus 1350 connecting different system components (including the storage apparatus 1310 and the processor 1320).

The bus 1350 represents one or more of several types of bus structures, including a memory bus or a memory controller, a peripheral bus, an accelerated graphics port, a processor, or a local bus using any of a plurality of bus structures. For example, these architectures include, but are not limited to, an Industrial Standard Architecture (ISA) bus, a Micro Channel Architecture (MAC) bus, an enhanced ISA bus, a Video Electronics Standards Association (VESA) local bus, and a Peripheral Component Interconnect (PCI) bus.

The electronic device 1300 typically includes a plurality of computer system readable media. These media may be any available media that can be accessed by the electronic device 1300, including volatile and non-volatile media as well as removable and non-removable media.

The storage apparatus 1310 may include a computer system-readable medium in the form of a volatile memory, for example, a random access memory (RAM) 1311 and/or a cache memory 1312. The electronic device 1300 may further include other removable/non-removable, and volatile/non-volatile computer system storage media. Only as an example, a storage system 1313 may be configured to read/write a non-removable, non-volatile magnetic medium (not shown in FIG. 13, typically referred to as a “hard disk drive”). Although not shown in FIG. 13, a magnetic disk drive configured to read/write a removable non-volatile magnetic disk (for example, a “floppy disk”) and an optical disc drive configured to read/write a removable non-volatile optical disc (for example, a CD-ROM, a DVD-ROM, or other optical media) may be provided. In these cases, each drive may be connected to the bus 1350 via one or more data medium interfaces. The storage apparatus 1310 may include at least one program product which has a group of program modules (for example, at least one program module) configured to execute the functions of the embodiments of the present disclosure.

A program/utility tool 1314 having a group (at least one) of program modules 1315 may be stored in, for example, the storage apparatus 1310. This program module 1315 includes, but is not limited to, an operating system, one or more applications, other program modules, and program data, and each of these examples or a certain combination thereof may include an implementation of a network environment. The program module 1315 typically executes the function and/or method in any embodiment described in the present disclosure.

The electronic device 1300 may also communicate with one or more external devices 1360 (such as a keyboard, a pointing device, and a display 1370), and may further communicate with one or more devices that enable a user to interact with the electronic device 1300, and/or communicate with any device (such as a network card and a modem) that enables the electronic device 1300 to communicate with one or more other computing devices. Such communication may be carried out via an input/output (I/O) interface 1330. In addition, the electronic device 1300 may also communicate with one or more networks (for example, a local area network (LAN), a wide area network (WAN), and/or a public network, such as the Internet) via a network adapter 1340. As shown in FIG. 13, the network adapter 1340 communicates with other modules of the electronic device 1300 through the bus 1350. It should be understood that although not shown in the drawing, other hardware and/or software modules may be used in conjunction with the electronic device 1300, the modules including, but not being limited to: microcode, device drivers, redundant processing units, external disk drive arrays, RAID systems, tape drives, data backup storage systems, and the like.

The processor 1320, by running programs stored in the storage apparatus 1310, executes various functional applications and data processing, such as implementing the method provided by the embodiments of the present disclosure.

The technique described herein may be implemented with hardware, software, firmware, or any combination thereof, unless specifically described as being implemented in a specific manner. Any features described as modules or components may also be implemented together in an integrated logical device, or separately implemented as discrete but interoperable logical devices. If implemented with software, the technique may be implemented at least in part by a non-transitory processor-readable storage medium that includes instructions, wherein when executed, the instructions perform one or more of the aforementioned methods. The non-transitory processor-readable data storage medium may form part of a computer program product that may include an encapsulation material. Program code may be implemented in a high-level procedural programming language or an object-oriented programming language so as to communicate with a processing system. If desired, the program code may also be implemented in an assembly language or a machine language. In fact, the mechanisms described herein are not limited to the scope of any particular programming language. In any case, the language may be a compiled language or an interpreted language.

One or a plurality of aspects of at least some embodiments may be implemented by representative instructions that are stored in a machine-readable medium and represent various logic in a processor, wherein when read by a machine, the representative instructions cause the machine to manufacture the logic for executing the technique described herein.

Such machine-readable storage media may include, but are not limited to, a non-transitory tangible arrangement of an article manufactured or formed by a machine or device, including storage media, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically erasable programmable read-only memory (EEPROM); a phase change memory (PCM); a magnetic or optical card; or any other type of medium suitable for storing electronic instructions.

Instructions may further be sent or received by means of a network interface device that uses any of a number of transport protocols (for example, Frame Relay, Internet Protocol (IP), Transfer Control Protocol (TCP), User Datagram Protocol (UDP), and Hypertext Transfer Protocol (HTTP)) and through a communication network using a transmission medium.

An example communication network may include a local area network (LAN), a wide area network (WAN), a packet data network (for example, the Internet), a mobile phone network (for example, a cellular network), a plain old telephone service (POTS) network, and a wireless data network (for example, Institute of Electrical and Electronics Engineers (IEEE) 802.11 standards referred to as Wi-Fi®, and IEEE 802.19 standards referred to as WiMax®), IEEE 802.15.4 standards, a peer-to-peer (P2P) network, and the like. In an example, the network interface device may include one or more physical jacks (for example, Ethernet, coaxial, or phone jacks) or one or more antennas for connection to the communication network. In an example, the network interface device may include a plurality of antennas that wirelessly communicate using at least one technique among single-input multiple-output (SIMO), multiple-input multiple-output (MIMO), or multiple-input single-output (MISO) techniques.

The term “transmission medium” should be considered to include any intangible medium capable of storing, encoding, or carrying instructions for execution by a machine, and the “transmission medium” includes digital or analog communication signals or any other intangible medium for facilitating communication of such software.

So far, the method for generating a low-resolution and high-resolution data pair, the method for training a neural network, the method for medical imaging, and the medical imaging system according to the present disclosure have been described, and the computer-readable storage medium and the computer program product that can implement the method have been further described.

The present disclosure proposes a method for generating a high-fidelity paired low-resolution and high-resolution data pair. The generated data pair may be used for supervised learning in the field of projection and image, which is beneficial to achieve better performance in medical imaging super-resolution deep learning tasks. Due to the requirement of pixel-to-pixel mapping relationship in supervised learning, the data pair usually needs to be derived from the same high-resolution data. For a clinical CT imaging system for human body scanning, it is difficult to perform the same scan, e.g., the same scanned subject and the same geometry, by using two different settings, low and high. It is also expensive and technically difficult to develop hardware components of a clinical CT imaging system for high-resolution human body scanning, such as a very small focal spot and a very small detector cell.

With the method of the present disclosure, the large number of low-resolution and high-resolution data pairs can be generated without actually performing a plurality of physical scans. By comparing and analyzing these data pairs, it is possible to better understand the performance differences of different imaging systems, optimize imaging algorithms, improve image quality, and develop new image processing techniques. For example, these data pairs may be used to train a neural network for implementing neural network-based image resolution improvement.

The present disclosure facilitates achieving super-resolution imaging of a medical imaging system, which has the following technical advantages: A low-dose CT image (low-resolution data) may be input into a trained neural network to obtain a high-resolution image (high-resolution data) equivalent to high-dose CT, so that the radiation dose can be reduced clinically while obtaining a high-quality image that meets the clinical diagnosis requirements. The use of the deep learning method to improve the image resolution without using a high-resolution imaging device/mode is helpful to improve the imaging efficiency. A super-resolution technology can overcome the limitation of hardware conditions, which is beneficial to reduce the cost. The improvement of the resolution and imaging efficiency of the image promotes the improvement of the diagnosis and treatment efficiency.

Some exemplary embodiments have been described above. However, it should be understood that various modifications can be made to the exemplary embodiments described above without departing from the spirit and scope of the present disclosure. For example, an appropriate result can be achieved if the described techniques are performed in a different order and/or if the components of the described system, architecture, device, or circuit are combined in a different manner and/or replaced or supplemented with additional components or equivalents thereof. Accordingly, the modified other embodiments also fall within the protection scope of the claims.

1. A method for generating a low-resolution and high-resolution data pair, comprising:
constructing a low-resolution medical imaging system and a high-resolution medical imaging system by using simulation software;
performing a first simulated scan on a simulated phantom of a scanned subject by using the low-resolution medical imaging system to obtain low-resolution data;
performing a second simulated scan on the simulated phantom of the scanned subject by using the high-resolution medical imaging system to obtain high-resolution data; and
associating the low-resolution data of the scanned subject with the high-resolution data of the scanned subject to generate a low-resolution and high-resolution data pair of the scanned subject.

2. The method according to claim 1, wherein the low-resolution medical imaging system includes a clinical CT imaging system suitable for scanning a human body, and the high-resolution medical imaging system includes a Micro-CT imaging system or a CBCT imaging system.

3. The method according to claim 1, wherein a voxel size of the simulated phantom is smaller than or equal to an equivalent size of a detector cell of the high-resolution medical imaging system at an isocenter of the high-resolution medical imaging system.

4. The method according to claim 3, further including:
acquiring a three-dimensional medical image of the scanned subject; and
converting the three-dimensional medical image into a three-dimensional voxel matrix to generate the simulated phantom, wherein each voxel in the three-dimensional voxel matrix is assigned a corresponding ray attenuation coefficient.

5. The method according to claim 4, wherein the three-dimensional medical image of the scanned subject is acquired by performing a real scan on the scanned subject by using a hardware-based high-resolution medical imaging system.

6. The method according to claim 1, wherein a positional relationship of a ray source, a scanned subject, and a detector used in the first simulated scan is the same as a positional relationship of a ray source, a scanned subject, and a detector used in the second simulated scan.

7. The method according to claim 1, wherein associating the low-resolution data of the scanned subject with the high-resolution data of the scanned subject includes registering the low-resolution data with the high-resolution data.

8. The method according to claim 1, wherein the low-resolution medical imaging system has at least one of a larger focal spot size, a larger detector cell size, and a smaller number of views per rotation than the high-resolution medical imaging system.

9. The method according to claim 1, further including:
performing a plurality of first simulated scans based on a plurality of imaging settings by using the low-resolution medical imaging system to obtain a plurality of pieces of low-resolution data;
performing a plurality of second simulated scans based on the plurality of imaging settings by using the high-resolution medical imaging system to obtain a plurality of pieces of high-resolution data; and
associating the low-resolution data and the high-resolution data obtained based on each imaging setting to generate a plurality of low-resolution and high-resolution data pairs.

10. The method according to claim 9, wherein the plurality of imaging settings have different imaging parameters, the imaging parameters including at least one of the following: anatomical structure content of the scanned subject, a position of the scanned subject, a direction of the scanned subject, a size of the scanned subject, a radiation dose, a noise level, and a parameter of a filter.

11. The method according to claim 1, wherein the low-resolution data includes low-resolution projection data, and the high-resolution data includes high-resolution projection data.

12. The method according to claim 11, wherein the projection data includes at least one of two-dimensional projection data for a view direction, a sinogram for a row direction, and three-dimensional projection data.

13. The method according to claim 1, wherein the low-resolution data includes a low-resolution reconstructed medical image, and the high-resolution data includes a high-resolution reconstructed medical image.

14. The method according to claim 1, wherein the low-resolution data includes a forward projection of a low-resolution reconstructed medical image, and the high-resolution data includes a forward projection of a high-resolution reconstructed medical image.

15. The method according to claim 1, wherein the scanned subject includes at least one of a temporal bone, a head, and limbs.
